(19) United States
(12) Patent Application Publication
(10) Pub. No.: US 2025/0225607 A1
(43) Pub. Date: Jul. 10, 2025

(54) Method and apparatus for calculating contrastive loss through multiple graphics processing units

(71) Applicant: Alipay (Hangzhou) Information Technology Co., Ltd., Hangzhou (CN)

(72) Inventors: Furong XU, Hangzhou (CN); Hanxiao ZHANG, Hangzhou (CN); Qingpei GUO, Hangzhou (CN); Ming YANG, Hangzhou (CN)

(21) Appl. No.: 19/009,785

(22) Filed: Jan. 3, 2025

(30) Foreign Application Priority Data
Jan. 5, 2024 (CN) 202410016072.9

(51) Int. Cl. G06T 1/20; G06V 10/74

(52) U.S. Cl. CPC G06T 1/20; G06V 10/761

(57) ABSTRACT

Embodiments of this specification provide a method and apparatus for calculating contrastive loss through multiple graphics processing units. The method includes: processing a feature of a target batch of samples through N graphics processing units divided into M processing unit groups, where each processing unit group includes one or more graphics processing units; separately determining, by each processing unit group, a partial feature similarity between features processed by a graphics processing unit, and storing the partial feature similarity into a corresponding video memory of the graphics processing unit included in the processing unit group; separately determining, according to the partial feature similarity stored in the corresponding video memory of the graphics processing unit included in each processing unit group, group contrastive loss corresponding to each processing unit group; and determining overall contrastive loss according to the group contrastive loss corresponding to each processing unit group.

### TECHNICAL FIELD

One or more embodiments of this specification relate to the fields of graphics processing units and deep learning, and in particular, to a method and apparatus for calculating contrastive loss through multiple graphics processing units.

### BACKGROUND

In modern society, more and more data is generated, including multi-modality data such as texts, images, audios, and videos. There is a complex association and interaction between the multi-modality data, so it is desirable to combine the data efficiently for example for multi-modality large model training to improve the analysis and processing capability of a multi-modality model for the multi-modality data. Self-supervised or semi-supervised training is often performed in training of the multi-modality large model by using contrastive loss. Because of a large data volume, training output of the model is accelerated by using a large quantity of graphics processing units (GPU) in training. In an existing solution of calculating contrastive loss through multiple graphics processing units, when a quantity of graphics processing units and a quantity of training batch of samples are relatively large, generally each graphics processing unit needs to consume a large quantity of video memories. This makes it difficult to increase a quantity of each training batch of samples, which prevents model training efficiency brought by the multiple graphics processing units from being improved.

### SUMMARY

Embodiments of this specification are intended to provide a method and apparatus for calculating contrastive loss through multiple graphics processing units. In a model training process through multiple graphics processing units, the multiple graphics processing units can be grouped, and corresponding group contrastive loss is separately calculated for each processing unit group. Further, overall contrastive loss of a batch of samples can be determined according to the group contrastive loss of each processing unit group. Therefore, consumption of a video memory of each graphics processing unit during model training through multiple graphics processing units can be greatly reduced, so a quantity of each training batch of samples can be increased in training, efficiency of model training through multiple graphics processing units can be improved, and deficiencies in the existing technology can be alleviated.

According to a first aspect, a method for calculating contrastive loss through multiple graphics processing units is provided, including:
processing a feature of a target batch of samples through N graphics processing units divided into M processing unit groups, where each processing unit group includes one or more graphics processing units, and each graphics processing unit separately processes a feature of at least one sample included in the target batch of samples; and separately determining, by each processing unit group, a similarity matrix between features processed by a graphics processing unit included in the processing unit group, and storing the similarity matrix into a corresponding video memory of the graphics processing unit included in the processing unit group; and
separately determining, according to the similarity matrix stored in the corresponding video memory of the graphics processing unit included in each processing unit group, group contrastive loss corresponding to each processing unit group; and determining overall contrastive loss according to the group contrastive loss corresponding to each processing unit group.

In a possible implementation, separately determining, by each processing unit group, the similarity matrix between features processed by the graphics processing unit included in the processing unit group, and storing the similarity matrix into the corresponding video memory of the graphics processing unit included in the processing unit group includes: separately determining, by each graphics processing unit in each processing unit group, a first similarity matrix between features processed by the processing unit group, and storing the first similarity matrix into a corresponding video memory of the graphics processing unit; and
separately determining, according to the similarity matrix stored in the corresponding video memory of the graphics processing unit included in each processing unit group, group contrastive loss corresponding to each processing unit group includes:
determining, by each graphics processing unit in each processing unit group according to the first similarity matrix stored in the corresponding video memory, first contrastive loss corresponding to the graphics processing unit; and
separately determining, according to the first contrastive loss corresponding to each graphics processing unit in each processing unit group, the group contrastive loss corresponding to each processing unit group.

In a possible implementation, separately determining, by each processing unit group, the similarity matrix between features processed by the graphics processing unit included in the processing unit group, and storing the similarity matrix into the corresponding video memory of the graphics processing unit included in the processing unit group includes: separately determining, by each graphics processing unit in each processing unit group, a second similarity matrix between a feature processed by the graphics processing unit and a feature processed by the processing unit group, and storing the second similarity matrix into a corresponding video memory of the graphics processing unit; and
separately determining, according to the similarity matrix stored in the corresponding video memory of the graphics processing unit included in each processing unit group, group contrastive loss corresponding to each processing unit group includes:
determining, by each graphics processing unit in each processing unit group according to the second similarity matrix stored in the corresponding video memory, second contrastive loss corresponding to the graphics processing unit; and
separately determining, according to the second contrastive loss corresponding to each graphics processing unit in each processing unit group, the group contrastive loss corresponding to each processing unit group.

In a possible implementation, determining overall contrastive loss according to the group contrastive loss corresponding to each processing unit group includes: determining the overall contrastive loss according to a weighted average value of the group contrastive loss corresponding to each processing unit group.

In a possible implementation, a quantity of graphics processing units included in each processing unit group is equal.

In a possible implementation, the target batch of samples includes one or more of a text sample, a picture sample, a video sample, and an audio sample.

According to a second aspect, an apparatus for calculating contrastive loss through multiple graphics processing units is provided, including:
a similarity determining unit, configured to: process a feature of a target batch of samples through N graphics processing units divided into M processing unit groups, where each processing unit group includes one or more graphics processing units, and each graphics processing unit separately processes a feature of at least one sample included in the target batch of samples; and separately determine, by each processing unit group, a similarity matrix between features processed by a graphics processing unit included in the processing unit group, and store the similarity matrix into a corresponding video memory of the graphics processing unit included in the processing unit group; and
an overall loss determining unit, configured to separately determine, according to the similarity matrix stored in the corresponding video memory of the graphics processing unit included in each processing unit group, group contrastive loss corresponding to each processing unit group; and determine overall contrastive loss according to the group contrastive loss corresponding to each processing unit group.

In a possible implementation, the similarity determining unit is further configured to: separately determine, by each graphics processing unit in each processing unit group, a first similarity matrix between features processed by the processing unit group, and store the first similarity matrix into a corresponding video memory of the graphics processing unit; and
the overall loss determining unit is further configured to: determine, by each graphics processing unit in each processing unit group according to the first similarity matrix stored in the corresponding video memory, first contrastive loss corresponding to the graphics processing unit; and separately determine, according to the first contrastive loss corresponding to each graphics processing unit in each processing unit group, the group contrastive loss corresponding to each processing unit group.

In a possible implementation, the similarity determining unit is further configured to: separately determine, by each graphics processing unit in each processing unit group, a second similarity matrix between a feature processed by the graphics processing unit and a feature processed by the processing unit group, and store the second similarity matrix into a corresponding video memory of the graphics processing unit; and
the overall loss determining unit is further configured to: determine, by each graphics processing unit in each processing unit group according to the second similarity matrix stored in the corresponding video memory, second contrastive loss corresponding to the graphics processing unit; and separately determine, according to the second contrastive loss corresponding to each graphics processing unit in each processing unit group, the group contrastive loss corresponding to each processing unit group.

In a possible implementation, the overall loss determining unit is further configured to determine the overall contrastive loss according to a weighted average value of the group contrastive loss corresponding to each processing unit group.

In a possible implementation, a quantity of graphics processing units included in each processing unit group is equal.

In a possible implementation, the target batch of samples includes one or more of a text sample, a picture sample, a video sample, and an audio sample.

According to a third aspect, a computer-readable storage medium is provided. The computer-readable storage medium stores a computer program. When the computer program is executed in a computer, the computer is enabled to perform the method according to the first aspect.

According to a fourth aspect, a computing device is provided, and includes a memory and a processor. The memory stores executable code. When the processor executes the executable code, the method according to the first aspect is implemented.

By using one or more of the method, the apparatus, the computing device, and the storage medium in the above-mentioned aspects, consumption of a video memory by each graphics processing unit during model training through multiple graphics processing units can be greatly reduced, so a quantity of each training batch of samples can be increased in training, and efficiency of model training through multiple graphics processing units can be improved.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description show merely some embodiments of this specification, and a person of ordinary skill in the art can derive other drawings from these accompanying drawings without creative efforts.

FIG. 1 is a schematic diagram illustrating a solution for calculating contrastive loss through multiple graphics processing units;

FIG. 2 is a schematic diagram illustrating a method for calculating contrastive loss through multiple graphics processing units, according to an embodiment of this specification;

FIG. 3 is a flowchart illustrating a method for calculating contrastive loss through multiple graphics processing units, according to an embodiment of this specification;

FIG. 4 is a schematic diagram illustrating a method for calculating contrastive loss through multiple graphics processing units, according to an embodiment of this specification;

FIG. 5 is a schematic diagram illustrating a method for calculating contrastive loss through multiple graphics processing units, according to another embodiment of this specification; and

FIG. 6 is a structural diagram illustrating an apparatus for calculating contrastive loss through multiple graphics processing units, according to an embodiment of this specification.

### DESCRIPTION OF EMBODIMENTS

The following describes the solutions provided in this specification with reference to the accompanying drawings.

As mentioned earlier, in modern society, more and more data is generated, including multi-modality data such as texts, images, audios, and videos. There is a complex association and interaction between the multi-modality data, so it is desirable to combine the data efficiently for example for multi-modality large model training to improve the analysis and processing capability of a multi-modality model for the multi-modality data. Self-supervised or semi-supervised training is often performed in training of the multi-modality large model by using contrastive loss. Contrastive loss is a loss function used to train a neural network. With contrastive loss, a mapping relationship can be learned, so after sample features having the same category but a relatively long feature distance in a high-dimensional space are mapped to a low-dimensional space by using a function, the feature distance becomes short. Points having different categories but a relatively short feature distance have a relatively long feature distance in the low-dimensional space after being mapped. Because of a large amount of sample data, a large quantity of graphics processing units (GPU) are often used in model training, for example, to process sample features and calculate contrastive loss, so as to accelerate a model training speed. During training of a neural network model, usually training loss is separately calculated according to multiple batches of samples, and multiple times of iterative update are performed on model parameters according to training loss corresponding to each batch of samples. In an existing solution for training model through multiple graphics processing units, when a sample quantity of any batch of samples is relatively large, generally each graphics processing unit needs to consume a large quantity of video memories. Specifically, each graphics processing unit needs to calculate similarity data of features according to features processed by all graphics processing units, and store the similarity data into a video memory. Therefore, when a quantity of features processed in any batch is relatively large, a large quantity of video memories of each graphics processing unit can be consumed in this processing manner, which makes it difficult to increase a quantity of each batch of samples in training, and impedes improvement of model training efficiency through multiple graphics processing units.

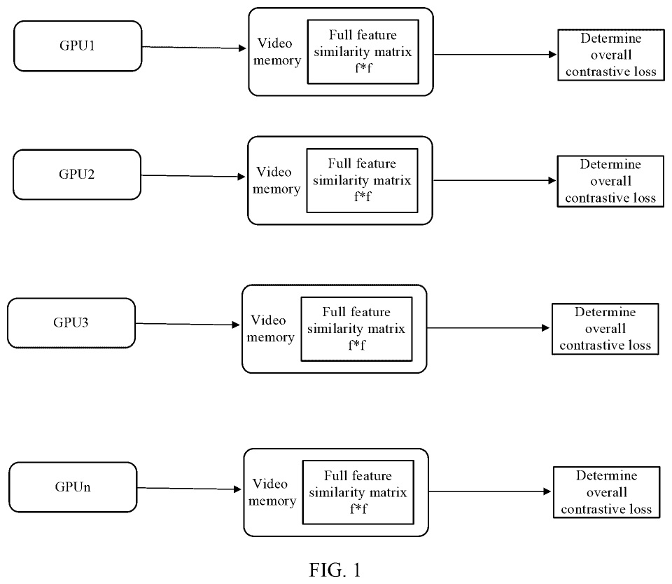

FIG. 1 is a schematic diagram illustrating a solution for calculating contrastive loss through multiple graphics processing units. In an example shown in FIG. 1, for example, n graphics processing units (GPU1 to GPUn) are used to process sample features of a target batch, for example, including f samples. Each graphics processing unit processes, for example, features of f/n samples. In an existing method for calculating contrastive loss of a target batch of samples, generally each graphics processing unit calculates a similarity matrix between full features (including a sample feature processed by the current processing unit and features processed by other n−1 graphics processing units) of the target batch of samples, and stores the similarity matrix between the full features into a corresponding video memory of each graphics processing unit. Then, each graphics processing unit separately calculates, according to the similarity matrix of the full features stored in the corresponding video memory, contrastive loss corresponding to the full features. In an example, for example, a total sample quantity f of the target batch of samples is 128, the sample features of the target batch of samples are processed by using a total of 16 GPUs, and each GPU processes sample features of eight samples. Generally, each GPU needs to calculate the similarity matrix (for example, dimensionality is 128*128) of the full sample features (128 samples) of the target batch and stores same into the corresponding video memory of the GPU, and calculates the contrastive loss corresponding to the full samples of the target batch of samples according to the similarity matrix of the full sample features stored in the video memory. It can be understood that because the corresponding video memory of each graphics processing unit stores similarity data of the full samples, a large quantity of video memories of each graphics processing unit can be consumed in this processing manner. In particular, if a sample quantity of each training batch is increased, consumption of a video memory by each graphics processing unit increases exponentially, a large quantity of consumption of the video memory makes it difficult to increase the sample quantity of each training batch, which prevents an increase in a training iteration speed of model training through multiple graphics processing units, and reduces training efficiency of model training through multiple graphics processing units.

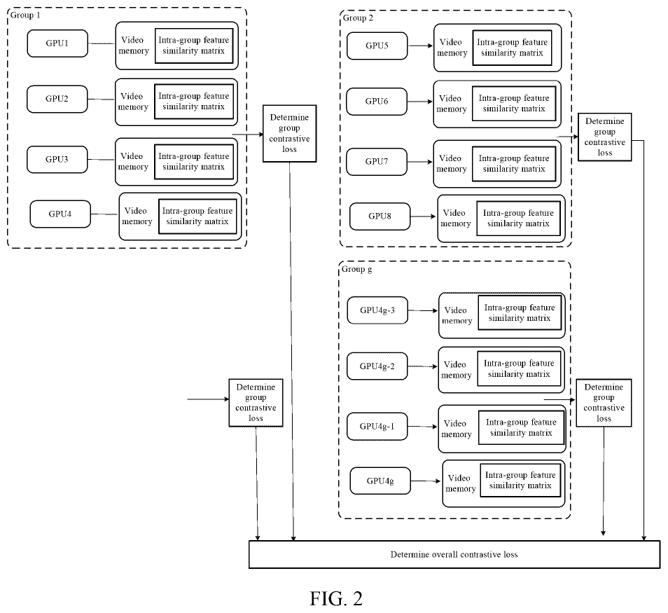

To alleviate the above-mentioned technical problem, an embodiment of this specification provides a method for calculating contrastive loss through multiple graphics processing units. FIG. 2 is a schematic diagram illustrating a method for calculating contrastive loss through multiple graphics processing units, according to an embodiment of this specification. In the example shown in FIG. 2, for example, graphics processing units configured to process sample features of a target batch of samples can be grouped. A graphics processing unit in each processing unit group determines, according to sample features processed by the current group of graphics processing units, a similarity matrix of the features processed by the current group of processing units, and stores the similarity matrix into corresponding video memories of the current group of graphics processing units. Then, a graphics processing unit in each processing unit group calculates, according to the similarity matrix stored in the corresponding video memory of the current processing unit, contrastive loss or group contrastive loss corresponding to the current group. Thereafter, overall contrastive loss corresponding to a full samples of the target batch can be determined according to the group contrastive loss of each processing unit group. In an example, for example, a total sample quantity f of the target batch of samples is 128, the sample features of the target batch of samples are processed by using a total of 16 GPUs, and each GPU processes sample features of eight samples. For example, the 16 GPUs can be divided into four groups, and each group of GPUs can separately determine a similarity matrix (for example, an intra-group feature similarity matrix whose dimensionality is 32*32) between sample features processed by the current group of GPUs, and store the similarity matrix into a corresponding video memory of each GPU in the current group. Then, the group contrastive loss corresponding to each group can be determined according to the similarity matrix stored in the corresponding video memory of each group of GPUs. Thereafter, the overall contrastive loss can be determined according to the group contrastive loss corresponding to each group.

The method has the following advantages: In a process of training a model through multiple graphics processing units, a similarity matrix of sample features of some samples processed by a current group of processing units in a target batch of samples can be stored in a corresponding video memory of each group of graphics processing units by grouping the graphics processing units. In addition, group contrastive loss corresponding to each group can be determined according to the stored similarity matrix of each group, and further, overall contrastive loss corresponding to the target batch of samples is determined according to the group contrastive loss corresponding to each group. Therefore, in the process of training a model through multiple graphics processing units, a quantity of feature similarity data stored in the corresponding video memory of each graphics processing unit is greatly reduced, and consumption of the video memory by each graphics processing unit is greatly reduced, so in a model training process, an iterative speed of training can be accelerated by increasing a quantity of graphics processing units, and efficiency of model training through multiple graphics processing units is improved.

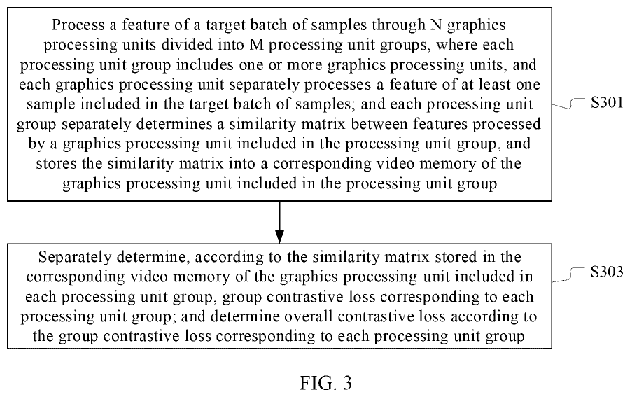

The following further describes a detailed process of the method. FIG. 3 is a flowchart illustrating a method for calculating contrastive loss through multiple graphics processing units, according to an embodiment of this specification. As shown in FIG. 3, the method includes at least the following steps.
Step S301: Process a feature of a target batch of samples through N graphics processing units divided into M processing unit groups, where each processing unit group includes one or more graphics processing units, and each graphics processing unit separately processes a feature of at least one sample included in the target batch of samples; and each processing unit group separately determines a similarity matrix between features processed by a graphics processing unit included in the processing unit group, and stores the similarity matrix into a corresponding video memory of the graphics processing unit included in the processing unit group.
Step S303: Separately determine, according to the similarity matrix stored in the corresponding video memory of the graphics processing unit included in each processing unit group, group contrastive loss corresponding to each processing unit group; and determine overall contrastive loss according to the group contrastive loss corresponding to each processing unit group.

First, in step S301, the feature of the target batch of samples is processed by the N graphics processing units divided into the M processing unit groups. Each processing unit group can include one or more graphics processing units, and each graphics processing unit separately processes a feature of at least one sample included in the target batch of samples. In an embodiment, a quantity of graphics processing units included in each processing unit group can be equal.

A graphics processing unit (GPU), also referred to as a display core, a video processor, a display chip, or a graphics chip, is a microprocessor that performs drawing operation on a personal computer, a workstation, a game console, and some mobile devices (such as a tablet computer and a smartphone). Generally, a motherboard expansion card with a graphics processing unit as a core is also referred to as a display card or a “graphics card”. Generally, each graphics processing unit has a corresponding video memory. A video memory is also referred to as a display memory, and is used to store data that is processed or to be processed by a graphics processing unit, or is a cache space used to assist the graphics processing unit in performing data exchange when a graphics processing task runs. Because the graphics processing unit can divide a computing task into smaller tasks and distribute them to multiple processing units for simultaneous processing, this data-based parallel computing manner is well suited for neural network training. Therefore, the graphics processing unit is also widely used for neural network training.

In this step, the feature of the target batch of samples can be processed by the N graphics processing units divided into the M processing unit groups. In different embodiments, a feature of a target batch of samples can be processed by using multiple graphics processing units in training different types of neural network models, which is not limited in this specification. Further, in different embodiments, specific manners of processing the feature of the target batch of samples through multiple graphics processing units can be different according to specific training models. In an embodiment, for example, a sample feature of the target batch of samples can be extracted through multiple graphics processing units according to a data processing manner corresponding to each network layer included in a trained model.

In different embodiments, specific modes of a sample included in the target batch of samples can be different, which is not limited in this specification. In an embodiment, the target batch of samples can include one or more of a text sample, a picture sample, a video sample, and an audio sample. In an embodiment, the target batch can further include a positive sample pair and a negative sample pair. The positive sample pair refers to a sample pair formed by samples of the same category, and the negative sample pair refers to a sample pair formed by samples of different categories. In different embodiments, different specific types of graphics processing units can be used, which is not limited in this specification.

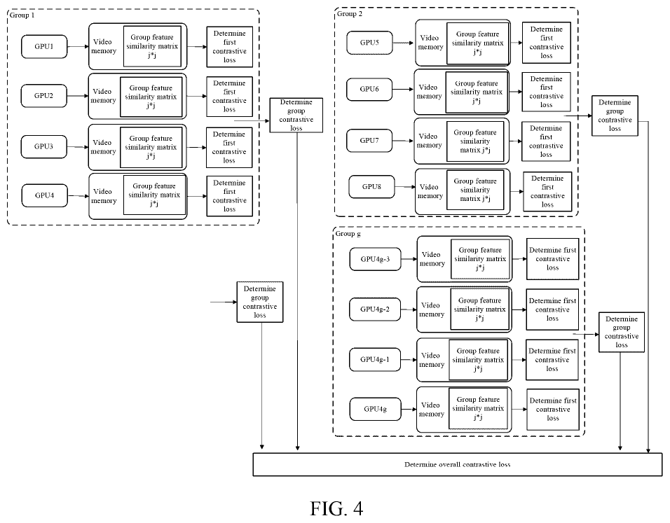

Each processing unit group can separately determine a similarity matrix between features processed by graphics processing units included in the processing unit group, and store the similarity matrix into a corresponding video memory of the graphics processing unit included in the processing unit group. In different embodiments, specific manners of determining and storing the similarity matrix by each processing unit group can be different. In an embodiment, each graphics processing unit in the processing unit group can separately determine a first similarity matrix between sample features processed by the group of processing units, and store the first similarity matrix into a corresponding video memory of the graphics processing unit. FIG. 4 is a schematic diagram illustrating a method for calculating contrastive loss through multiple graphics processing units, according to an embodiment of this specification. As shown in FIG. 4, for example, g groups of GPUs, each group with 4 GPUS, that is, a total of 4*g GPUs process sample features of f samples of a target batch. Each GPU can process, for example, sample features of f/4g samples, and each group of GPUs can process sample features of f/g samples. For any GPU group, each GPU in the group can separately determine a first similarity matrix (for example, dimensionality is j*j) between features processed by the current group of GPUs (for example, dimensionality is j, and j=f/g), that is, a matrix used to store similarity between every two features in the features processed by the current group of GPUs, and store the first similarity matrix into a video memory corresponding to the GPU. In different specific embodiments, specific manners of determining similarity between two features can be different. In a specific embodiment, for example, similarity between two features can be determined by using a Euclidean distance between the two features.

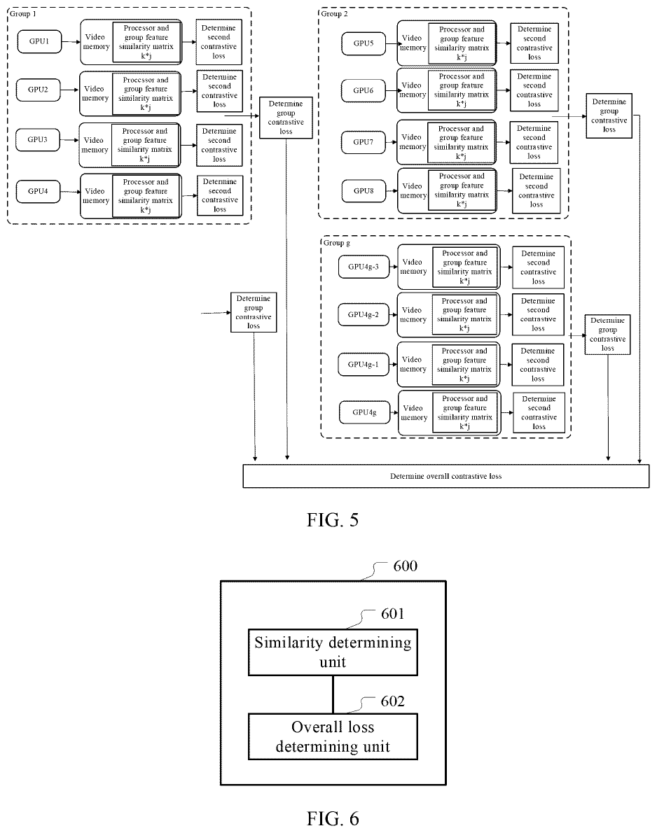

In another embodiment, each graphics processing unit in each processing unit group can separately determine a second similarity matrix between a feature processed by the graphics processing unit and a feature processed by the processing unit group, and store the second similarity matrix into a corresponding video memory of the graphics processing unit. FIG. 5 is a schematic diagram illustrating a method for calculating contrastive loss through multiple graphics processing units, according to another embodiment of this specification. As shown in FIG. 5, for example, g groups of GPUs, each group with 4 GPUs, that is, a total of 4*g GPUs process sample features of f samples of a target batch. Each GPU can process, for example, sample features of f/4g samples, and each group of GPUs can process sample features of f/g samples. For any GPU group, each GPU in the group can separately determine a second similarity matrix (for example, dimensionality is k*j) between a sample feature (for example, k, and k=f/4g) processed by the processing unit and a sample feature (for example, j, and j=f/g) processed by the current group of GPUs, and store the second similarity matrix into a video memory corresponding to the GPU.

Then, in step S303, group contrastive loss corresponding to each processing unit group is separately determined according to the similarity matrix stored in the corresponding video memory of the graphics processing unit included in each processing unit group; and overall contrastive loss is determined according to the group contrastive loss corresponding to each processing unit group.

As described above, in different embodiments, specific manners of determining and storing the similarity matrix by each processing unit group can be different. Therefore, in different embodiments, specific manners of determining the group contrastive loss corresponding to each processing unit group can also be different. In an embodiment in which each graphics processing unit in each processing unit group determines and stores a first similarity matrix, each graphics processing unit in each processing unit group can determine, according to the first similarity matrix stored in the corresponding video memory, first contrastive loss corresponding to the graphics processing unit. In different specific embodiments, the first contrastive loss can be determined by using different specific loss functions, which is limited in this specification. In a specific embodiment, the first contrastive loss can be determined by using the following loss function:

$$L = \frac{1}{2 N} {\sum }_{n = 1}^{N} ( ( 1 - {u}_{i} ) {D}_{w}^{2} + {u}_{i} \cdot {max ( 0 , m - {D}_{w} )}^{2} ) ,$$

where L is the first contrastive loss, N is a quantity of sample features processed in a current group, uᵢ is a sample match label, D_{w} is sample feature similarity (for example, a Euclidean distance between sample features), and m is a predetermined threshold. Further, the group contrastive loss corresponding to each processing unit group can be determined according to the first contrastive loss corresponding to each graphics processing unit in each processing unit group, as shown in FIG. 4. In different specific embodiments, specific manners of determining the group contrastive loss according to the first contrastive loss corresponding to each graphics processing unit can be different. In a specific embodiment, for example, the group contrastive loss can be determined according to an average value of the first contrastive loss corresponding to each graphics processing unit.

In an embodiment in which each graphics processing unit in each processing unit group determines and stores a second similarity matrix, each graphics processing unit in each processing unit group can determine, according to the second similarity matrix stored in the corresponding video memory, second contrastive loss corresponding to the graphics processing unit. Similar to the first contrastive loss, in different specific embodiments, the second contrastive loss can also be determined by using different specific loss functions. Details are omitted here for simplicity. Further, the group contrastive loss corresponding to each processing unit group can be determined according to the second contrastive loss corresponding to each graphics processing unit in each processing unit group, as shown in FIG. 5. In different specific embodiments, specific manners of determining the group contrastive loss according to the second contrastive loss corresponding to each graphics processing unit can be different. In a specific embodiment, for example, the group contrastive loss can be determined according to an average value of the second contrastive loss corresponding to each graphics processing unit.

In different embodiments, specific manners of determining the overall contrastive loss according to the group contrastive loss corresponding to each processing unit group can also be different. In an embodiment, the overall contrastive loss can be determined according to a weighted average value of the group contrastive loss corresponding to each processing unit group.

According to an embodiment of yet another aspect, an apparatus for calculating contrastive loss through multiple graphics processing units is further provided. FIG. 6 is a structural diagram illustrating an apparatus for calculating contrastive loss through multiple graphics processing units, according to an embodiment of this specification. As shown in FIG. 6, the apparatus 600 includes:
a similarity determining unit 601, configured to: process a feature of a target batch of samples through N graphics processing units divided into M processing unit groups, where each processing unit group includes one or more graphics processing units, and each graphics processing unit separately processes a feature of at least one sample included in the target batch of samples; and separately determine, by each processing unit group, a similarity matrix between features processed by a graphics processing unit included in the processing unit group, and store the similarity matrix into a corresponding video memory of the graphics processing unit included in the processing unit group; and
an overall loss determining unit 602, configured to: separately determine, according to the similarity matrix stored in the corresponding video memory of the graphics processing unit included in each processing unit group, group contrastive loss corresponding to each processing unit group; and determine overall contrastive loss according to the group contrastive loss corresponding to each processing unit group.

In an embodiment, the similarity determining unit 601 can be further configured to: separately determine, by each graphics processing unit in each processing unit group, a first similarity matrix between features processed by the processing unit group, and store the first similarity matrix into a corresponding video memory of the graphics processing unit; and
the overall loss determining unit 602 can be further configured to: determine, by each graphics processing unit in each processing unit group according to the first similarity matrix stored in the corresponding video memory, first contrastive loss corresponding to the graphics processing unit; and separately determine, according to the first contrastive loss corresponding to each graphics processing unit in each processing unit group, the group contrastive loss corresponding to each processing unit group.

In an embodiment, the similarity determining unit 601 can be further configured to: separately determine, by each graphics processing unit in each processing unit group, a second similarity matrix between a feature processed by the graphics processing unit and a feature processed by the processing unit group, and store the second similarity matrix into a corresponding video memory of the graphics processing unit; and
the overall loss determining unit 602 can be further configured to: determine, by each graphics processing unit in each processing unit group according to the second similarity matrix stored in the corresponding video memory, second contrastive loss corresponding to the graphics processing unit; and separately determine, according to the second contrastive loss corresponding to each graphics processing unit in each processing unit group, the group contrastive loss corresponding to each processing unit group.

In an embodiment, the overall loss determining unit 601 can be further configured to: determine the overall contrastive loss according to a weighted average value of the group contrastive loss corresponding to each processing unit group.

In an embodiment, a quantity of graphics processing units included in each processing unit group is equal.

In an embodiment, the target batch of samples include one or more of a text sample, a picture sample, a video sample, and an audio sample.

According to still another aspect of an embodiment of this specification, a computer-readable storage medium is provided. The computer-readable storage medium stores a computer program. When the computer program is executed in a computer, the computer is enabled to perform any one of the above-mentioned methods.

According to yet another aspect of an embodiment of this specification, a computing device is provided, and includes a memory and a processor. The memory stores executable code. When the processor executes the executable code, any one of the above-mentioned methods is implemented.

It should be understood that descriptions such as “first” and “second” in this specification are merely intended to distinguish between similar concepts for ease of description, and do not impose a limitation.

Although the one or more embodiments of this specification provide the operation steps of the method according to an embodiment or a flowchart, the conventional or non-creative means can include more or fewer operation steps. A sequence of the steps listed in the embodiment is merely one of numerous execution sequences of the steps, and does not represent a unique execution sequence. In actual execution of an apparatus or a terminal product, execution can be performed based on a method sequence shown in the embodiments or the accompanying drawings, or performed in parallel (for example, a parallel processor or a multi-thread processing environment, or even a distributed data processing environment). Terms “include”, “contain”, or their any other variant is intended to cover non-exclusive inclusion, so a process, a method, an article, or a device that includes a series of elements not only includes these very elements, but also includes other elements which are not expressly listed, or further includes elements inherent to such process, method, article, or device. Without more constraints, it is not excluded that the process, method, product, or device including the described elements can also include additional identical or equivalent elements.

For ease of description, the above-mentioned apparatus is described by dividing the apparatus into various modules based on functions. Certainly, when the one or more embodiments of this specification are implemented, the functions of each module can be implemented in one or more pieces of software and/or hardware, or a module implementing a same function can be implemented by a combination of a plurality of submodules or subunits. The described apparatus embodiment is merely an example. For example, the unit division is merely logical function division and can be other division in actual implementation. For example, a plurality of units or components can be combined or integrated into another system, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

A person skilled in the art can recognize that one or more embodiments of this specification can be provided as a method, system, or computer program product. Therefore, one or more embodiments of this specification can use a form of hardware only embodiments, software only embodiments, or embodiments with a combination of software and hardware. In addition, one or more embodiments of this specification can use a form of a computer program product that is implemented on one or more computer-usable storage media (including but not limited to a disk memory, a CD-ROM, an optical memory, etc.) that include computer-usable program code.

One or more embodiments of this specification can be described in the general context of computer-executable instructions, for example, a program module. Usually, the program module includes a routine, a program, an object, a component, a data structure, etc. executing a specific task or implementing a specific abstract data type. Or one or more embodiments of this specification can be practiced in distributed computing environments. In the distributed computing environments, tasks are performed by remote processing devices connected through a communication network. In the distributed computing environments, program modules can be located in local and remote computer storage media including storage devices.

The embodiments of this specification are described in a progressive way. For same or similar parts in the embodiments, refer to each other. Each embodiment focuses on a difference from the other embodiments. Particularly, the system embodiments are basically similar to the method embodiments, and therefore are described briefly. For related parts, references can be made to some descriptions in the method embodiments. In the descriptions of this specification, reference to the descriptions of the terms “one embodiment”, “some embodiments”, “example”, “specific example”, or “some examples” means that specific features, structures, materials, or characteristics described in the embodiments or examples are included in at least one embodiment or example of this specification. In this specification, example descriptions of the above-mentioned terms do not need to be specific to the same embodiment or example. In addition, the described specific features, structures, materials, or characteristics can be combined in a proper way in any one or more embodiments or examples. In addition, a person skilled in the art can integrate or combine different embodiments or examples and characteristics of different embodiments or examples described in this specification, provided that they do not conflict with each other.

The previous descriptions are merely embodiments of the one or more embodiments of this specification, and are not intended to limit the one or more embodiments of this specification. For a person skilled in the art, the one or more embodiments of this specification can have various modifications and changes. Any modification, equivalent replacement, or improvement made without departing from the spirit and principle of this specification shall fall within the scope of the claims.

1. A method for calculating contrastive loss through multiple graphics processing units, comprising:
processing a feature of a target batch of samples through N graphics processing units divided into M processing unit groups, wherein each processing unit group comprises one or more graphics processing units, and each graphics processing unit separately processes a feature of at least one sample comprised in the target batch of samples; and separately determining, by each processing unit group, a similarity matrix between features processed by a graphics processing unit comprised in the processing unit group, and storing the similarity matrix into a corresponding video memory of the graphics processing unit comprised in the processing unit group; and
separately determining, according to the similarity matrix stored in the corresponding video memory of the graphics processing unit comprised in each processing unit group, group contrastive loss corresponding to each processing unit group; and determining overall contrastive loss according to the group contrastive loss corresponding to each processing unit group.

2. The method according to claim 1, wherein separately determining, by each processing unit group, the similarity matrix between features processed by the graphics processing unit comprised in the processing unit group, and storing the similarity matrix into the corresponding video memory of the graphics processing unit comprised in the processing unit group comprises: separately determining, by each graphics processing unit in each processing unit group, a first similarity matrix between features processed by the processing unit group, and storing the first similarity matrix into a corresponding video memory of the graphics processing unit; and
separately determining, according to the similarity matrix stored in the corresponding video memory of the graphics processing unit comprised in each processing unit group, group contrastive loss corresponding to each processing unit group comprises:
determining, by each graphics processing unit in each processing unit group according to the first similarity matrix stored in the corresponding video memory, first contrastive loss corresponding to the graphics processing unit; and
separately determining, according to the first contrastive loss corresponding to each graphics processing unit in each processing unit group, the group contrastive loss corresponding to each processing unit group.

3. The method according to claim 1, wherein separately determining, by each processing unit group, the similarity matrix between features processed by the graphics processing unit comprised in the processing unit group, and storing the similarity matrix into the corresponding video memory of the graphics processing unit comprised in the processing unit group comprises: separately determining, by each graphics processing unit in each processing unit group, a second similarity matrix between a feature processed by the graphics processing unit and a feature processed by the processing unit group, and storing the second similarity matrix into a corresponding video memory of the graphics processing unit; and
separately determining, according to the similarity matrix stored in the corresponding video memory of the graphics processing unit comprised in each processing unit group, group contrastive loss corresponding to each processing unit group comprises:
determining, by each graphics processing unit in each processing unit group according to the second similarity matrix stored in the corresponding video memory, second contrastive loss corresponding to the graphics processing unit; and
separately determining, according to the second contrastive loss corresponding to each graphics processing unit in each processing unit group, the group contrastive loss corresponding to each processing unit group.

4. The method according to claim 1, wherein determining overall contrastive loss according to the group contrastive loss corresponding to each processing unit group comprises:
determining the overall contrastive loss according to a weighted average value of the group contrastive loss corresponding to each processing unit group.

5. The method according to claim 1, wherein a quantity of graphics processing units comprised in each processing unit group is equal.

6. The method according to claim 1, wherein the target batch of samples comprises one or more of a text sample, a picture sample, a video sample, and an audio sample.

7-12. (canceled)

13. A non-transitory computer-readable storage medium, wherein the non-transitory computer-readable storage medium stores a computer program, which when executed by a processor causes the processor to:
process a feature of a target batch of samples through N graphics processing units divided into M processing unit groups, wherein each processing unit group comprises one or more graphics processing units, and each graphics processing unit separately processes a feature of at least one sample comprised in the target batch of samples; and separately determine, by each processing unit group, a similarity matrix between features processed by a graphics processing unit comprised in the processing unit group, and store the similarity matrix into a corresponding video memory of the graphics processing unit comprised in the processing unit group; and
separately determine, according to the similarity matrix stored in the corresponding video memory of the graphics processing unit comprised in each processing unit group, group contrastive loss corresponding to each processing unit group; and determine overall contrastive loss according to the group contrastive loss corresponding to each processing unit group.

14. A computing device, comprising a memory and a processor, wherein the memory stores executable code, and when the processor executes the executable code, the computing device is caused to:
process a feature of a target batch of samples through N graphics processing units divided into M processing unit groups, wherein each processing unit group comprises one or more graphics processing units, and each graphics processing unit separately processes a feature of at least one sample comprised in the target batch of samples; and separately determine, by each processing unit group, a similarity matrix between features processed by a graphics processing unit comprised in the processing unit group, and store the similarity matrix into a corresponding video memory of the graphics processing unit comprised in the processing unit group; and
separately determine, according to the similarity matrix stored in the corresponding video memory of the graphics processing unit comprised in each processing unit group, group contrastive loss corresponding to each processing unit group; and determine overall contrastive loss according to the group contrastive loss corresponding to each processing unit group.

15. The non-transitory computer-readable storage medium according to claim 13, wherein the processor being caused to separately determine, by each processing unit group, the similarity matrix between features processed by the graphics processing unit comprised in the processing unit group, and store the similarity matrix into the corresponding video memory of the graphics processing unit comprised in the processing unit group comprises being caused to: separately determine, by each graphics processing unit in each processing unit group, a first similarity matrix between features processed by the processing unit group, and store the first similarity matrix into a corresponding video memory of the graphics processing unit; and
the processor being caused to separately determine, according to the similarity matrix stored in the corresponding video memory of the graphics processing unit comprised in each processing unit group, group contrastive loss corresponding to each processing unit group comprises being caused to:
determine, by each graphics processing unit in each processing unit group according to the first similarity matrix stored in the corresponding video memory, first contrastive loss corresponding to the graphics processing unit; and
separately determine, according to the first contrastive loss corresponding to each graphics processing unit in each processing unit group, the group contrastive loss corresponding to each processing unit group.

16. The non-transitory computer-readable storage medium according to claim 13, wherein the processor being caused to separately determine, by each processing unit group, the similarity matrix between features processed by the graphics processing unit comprised in the processing unit group, and store the similarity matrix into the corresponding video memory of the graphics processing unit comprised in the processing unit group comprises being caused to: separately determine, by each graphics processing unit in each processing unit group, a second similarity matrix between a feature processed by the graphics processing unit and a feature processed by the processing unit group, and store the second similarity matrix into a corresponding video memory of the graphics processing unit; and
the processor being caused to separately determine, according to the similarity matrix stored in the corresponding video memory of the graphics processing unit comprised in each processing unit group, group contrastive loss corresponding to each processing unit group comprises being caused to:
determine, by each graphics processing unit in each processing unit group according to the second similarity matrix stored in the corresponding video memory, second contrastive loss corresponding to the graphics processing unit; and
separately determine, according to the second contrastive loss corresponding to each graphics processing unit in each processing unit group, the group contrastive loss corresponding to each processing unit group.

17. The non-transitory computer-readable storage medium according to claim 13, wherein the processor being caused to determine overall contrastive loss according to the group contrastive loss corresponding to each processing unit group comprises being caused to:
determine the overall contrastive loss according to a weighted average value of the group contrastive loss corresponding to each processing unit group.

18. The non-transitory computer-readable storage medium according to claim 13, wherein a quantity of graphics processing units comprised in each processing unit group is equal.

19. The non-transitory computer-readable storage medium according to claim 13, wherein the target batch of samples comprises one or more of a text sample, a picture sample, a video sample, and an audio sample.

20. The computing device according to claim 14, wherein the computing device being caused to separately determine, by each processing unit group, the similarity matrix between features processed by the graphics processing unit comprised in the processing unit group, and store the similarity matrix into the corresponding video memory of the graphics processing unit comprised in the processing unit group comprises being caused to: separately determine, by each graphics processing unit in each processing unit group, a first similarity matrix between features processed by the processing unit group, and store the first similarity matrix into a corresponding video memory of the graphics processing unit; and
the computing device being caused to separately determine, according to the similarity matrix stored in the corresponding video memory of the graphics processing unit comprised in each processing unit group, group contrastive loss corresponding to each processing unit group comprises being caused to:
determine, by each graphics processing unit in each processing unit group according to the first similarity matrix stored in the corresponding video memory, first contrastive loss corresponding to the graphics processing unit; and
separately determine, according to the first contrastive loss corresponding to each graphics processing unit in each processing unit group, the group contrastive loss corresponding to each processing unit group.

21. The computing device according to claim 14, wherein the computing device being caused to separately determine, by each processing unit group, the similarity matrix between features processed by the graphics processing unit comprised in the processing unit group, and store the similarity matrix into the corresponding video memory of the graphics processing unit comprised in the processing unit group comprises being caused to: separately determine, by each graphics processing unit in each processing unit group, a second similarity matrix between a feature processed by the graphics processing unit and a feature processed by the processing unit group, and store the second similarity matrix into a corresponding video memory of the graphics processing unit; and
the computing device being caused to separately determine, according to the similarity matrix stored in the corresponding video memory of the graphics processing unit comprised in each processing unit group, group contrastive loss corresponding to each processing unit group comprises being caused to:
determine, by each graphics processing unit in each processing unit group according to the second similarity matrix stored in the corresponding video memory, second contrastive loss corresponding to the graphics processing unit; and
separately determine, according to the second contrastive loss corresponding to each graphics processing unit in each processing unit group, the group contrastive loss corresponding to each processing unit group.

22. The computing device according to claim 14, wherein the computing device being caused to determine overall contrastive loss according to the group contrastive loss corresponding to each processing unit group comprises being caused to:
determine the overall contrastive loss according to a weighted average value of the group contrastive loss corresponding to each processing unit group.

23. The computing device according to claim 14, wherein a quantity of graphics processing units comprised in each processing unit group is equal.

24. The computing device according to claim 14, wherein the target batch of samples comprises one or more of a text sample, a picture sample, a video sample, and an audio sample.
